(19) United States
(12) Patent Application Publication
(10) Pub. No.: US 2026/0294729 A1
(43) Pub. Date: Oct. 1, 2026

(54) Smart Hand Massager

(71) Applicant: Minoru Kogure, Rolling Hills Estates, CA (US)

(72) Inventor: Minoru Kogure, Rolling Hills Estates, CA (US)

(21) Appl. No.: 19/097,594

(22) Filed: Apr. 1, 2025

(51) Int. Cl. A61H 15/00; A61H 7/00; A61H 23/02

(52) U.S. Cl. CPC A61H 15/0078; A61H 7/001; A61H 23/0254; A61H 2015/0014; A61H 2201/0207; A61H 2201/1635; A61H 2201/5043; A61H 2201/5046; A61H 2201/5048; A61H 2205/065

(57) ABSTRACT

A smart hand massager is disclosed. It comprises: a housing having an opening for letting a hand access an operating space therein; a massage module being controlled to massage a portion of the hand in different modes; at least one speaker being controlled to play music or sound; a hand sensor sensing the hand accessing the operating space and sending an activating signal when the hand is sensed; a control panel being operated to send commands; a control module signally connected to the control panel, hand sensor, speaker and massage module, controlling the massage module to operate in a specified mode and the at least one speaker to play a specified music or sound according to the commands from the control panel when the activating signal is received; and a power module receiving power from a power source, transferring and providing the power to the elements electrically connected thereto.

### FIELD OF THE INVENTION

The present invention relates to a hand massager. More particularly, the present invention relates to a smart hand massager which is able to be activated by sensing the existence of a hand, operate in different modes for different users, play different music according to user preferences and display different visual images for guiding users' mood.

### BACKGROUND OF THE INVENTION

An electronic hand massager is a device that uses mechanical technology to massage the hands of a user under electronic control. It typically employs air compression, vibrations, rolling mechanisms, or heat therapy to relax the muscles and joints of the hand, fingers, and wrist. Compared to traditional manual massage, an electronic hand massager provides a more consistent and deeper massage experience, with adjustable intensity and modes to suit individual needs. The electronic hand massager may relieve hand fatigue and soreness, promote blood circulation, reduce joint pressure and stiffness, and provide relaxation and stress relief. As people spend more and more time in front of computers using keyboards and mice, the demand for the electronic hand massager has also increased.

Although the electronic hand massager is easy to use, it cannot provide diversity scenarios when in use. Users always have to face the same electronic hand massager and wait for the massage time to pass. It is boring during the massage time. If an electronic hand massager can add some entertainment functions to change the user's mood, then the whole process of hand massage is a synchronous exercise for relaxation of body and mind. However, there is no such product in the market.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to fulfill the requirements mentioned above, a smart hand massager is disclosed. The smart hand massager comprises: a housing, having an opening for letting a hand access an operating space therein; a massage module, installed in the operating space, being controlled to massage a portion of the hand in different modes; at least one speaker, installed on the housing, being controlled to play music or sound; a hand sensor, installed in the operating space, sensing the hand accessing the operating space and sending an activating signal when the hand is sensed; a control panel, installed on the housing, being operated to send commands; a control module, installed in the operating space and signally connected to the control panel, the hand sensor, the at least one speaker and the massage module, controlling the massage module to operate in a specified mode and the at least one speaker to play a specified music or sound according to the commands from the control panel when the activating signal is received; and a power module, installed on the housing, receiving power from a power source, transferring the power and providing transferred power to the control module, the control panel, the hand sensor, the at least one speaker and the massage module electrically connected thereto.

The smart hand massager may further comprise an image board, removably or rotatably mounted on the housing, for showing an image picture thereon.

The smart hand massager may also further comprise a monitor, removably fixed on the housing, electrically connected to the power module and signally connected to the control module, displaying a movie or an image according to a command from the control panel through the control module. The monitor may be a Liquid Crystal Display (LCD), a Thin Film Transistor Liquid Crystal Display (TFT-LCD), an Organic Light Emitting Diode (OLED) display, a plasma display, a Light Emitting Diode (LED) display, or an e-paper. Thus, the control module should include a memory unit to store files of music, sounds, movies and images.

The smart hand massager may also further comprise a heater, installed in the operating space, electrically connected to the power module and signally connected to the control module, generating heat in the operating space at different temperatures according to a command from the control panel through the control module.

According to the present invention, the massage module may be pressure type, roller type or vibration type. Different modes operate in different strengths to the hand, different durations, different speeds or different periods. The hand sensor may be an inductive sensor, a capacitive sensor, a photoelectric sensor, an ultrasonic sensor, an infrared sensor, a radar sensor or a sonar sensor.

The control panel may be a touch panel and form a plurality of virtual buttons, and one specified command is sent by the control panel when a corresponding virtual button is pressed. The control panel may have a number of physical buttons, and one specified command is sent by the control panel when a corresponding physical button is pressed.

The power module may comprise a power distribution circuit and a battery box electrically connected thereto. Thus, the power source is a battery or batteries electrically installed in the battery box. The power module may also comprise a power distribution circuit, a transformer electrically connected to the power distribution circuit, and a wire electrically connected to the transformer. The power source becomes an electrical socket that a plug of the wire plugged into.

According to the present invention, a separation cloth cover may be further fixed on the opening and extended into the operating space to separate the hand from the massage module.

Compared with palm massagers on the market, the smart hand massager has advantages below. First, the smart hand massager is activated only when a hand accesses the housing, even the smart hand massager is powered on. It can save power if one user turns on the smart hand massager but forgets to use it. Secondly, the smart hand massager can provide music or sound to help users pass the boring massage time. Thirdly, the smart hand massager has different operating modes for users to choose. Last, the smart hand massager provides visual enjoyment by the monitor or image board. Thus, the requirements above can be fulfilled.

### BRIEF DESCRIPTION OF THE DRAWINGS

FIG. 1 is an appearance diagram of a smart hand massager according to a first embodiment of the present invention.

FIG. 2 is a block diagram of the smart hand massager in the first embodiment.

FIG. 3 is a sectional drawing of the smart hand massager with a hand accesses into an operating space in the smart hand massager.

FIG. 4 is a front view of the smart hand massager when an image board is mounted on.

FIG. 5 is a side view of the smart hand massager when the image board is mounted on.

FIG. 6 is a block diagram of a smart hand massager according to a second embodiment of the present invention.

FIG. 7 is a side view of the smart hand massager when a monitor is fixed on.

### DETAILED DESCRIPTION OF THE PREFERRED EMBODIMENTS

The present invention will now be described more specifically with reference to the following embodiments.

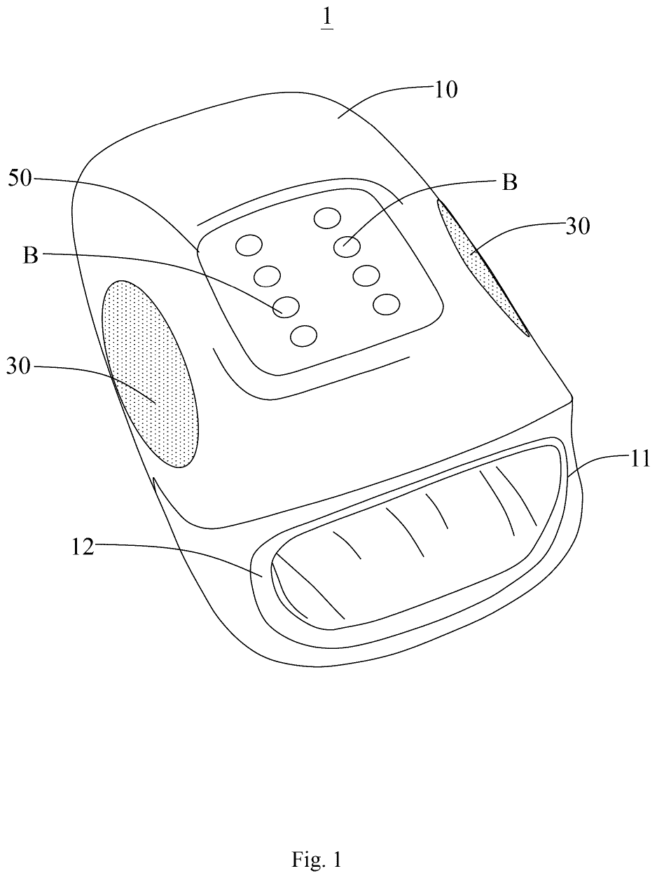

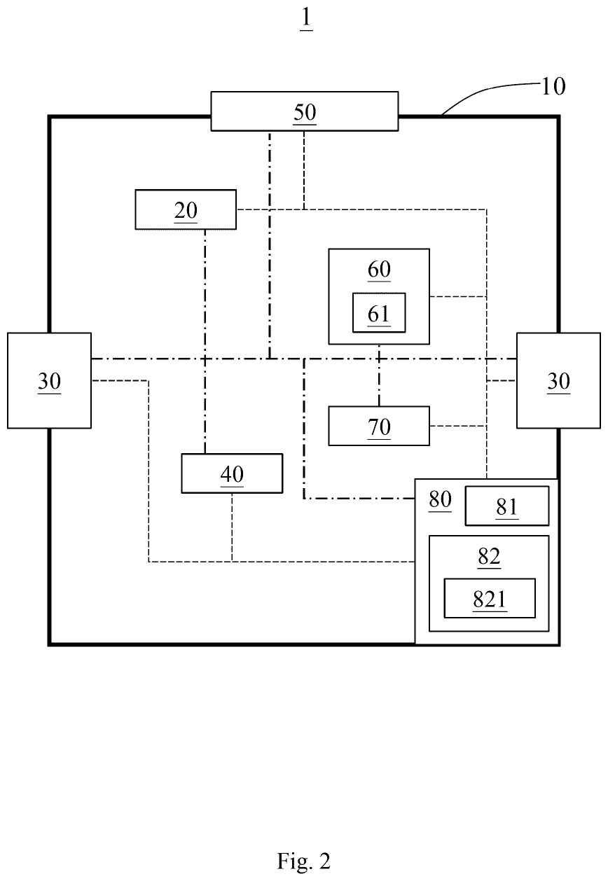

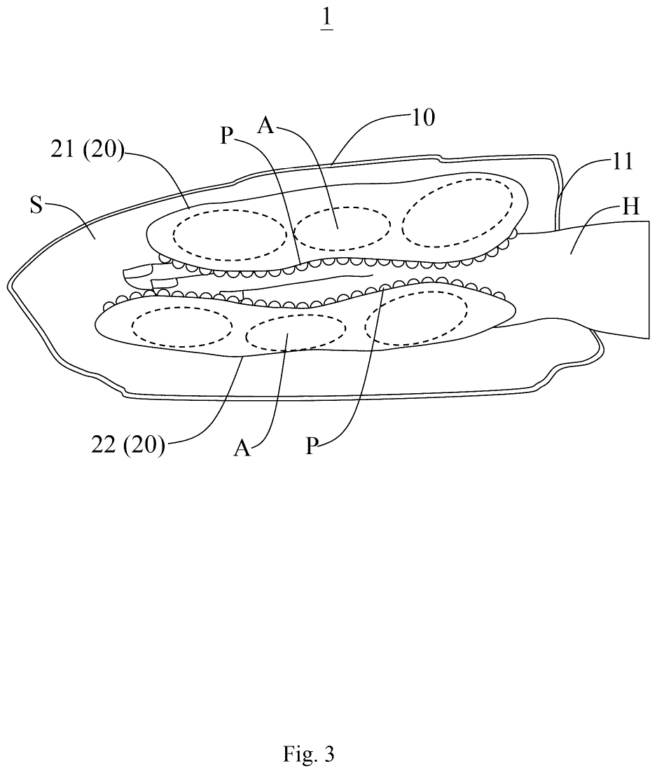

See FIG. 1 to FIG. 3. FIG. 1 is an appearance diagram of a smart hand massager 1 according to a first embodiment of the present invention. FIG. 2 is a block diagram of the smart hand massager 1 in the first embodiment. FIG. 3 is a sectional drawing of the smart hand massager 1 with a hand H accesses into an operating space S in the smart hand massager 1. The smart hand massager 1 includes a housing 10, a massage module 20, at least one speaker 30, a hand sensor 40, a control panel 50, a control module 60, a heater 70 and a power module 80. For the convenience of explanation, the components in FIG. 2 are connected by dashed lines to indicate electrical connections, and by dot-dashed lines to indicate signal connections. The components, functions and usage of the smart hand massager 1 will be explained with the corresponding diagrams.

The housing 10 is a protective case of the smart hand massager 1. The appearance of the housing 10 is not limited by the present invention. In the embodiments of the present invention, the housing 10 has the same appearance as shown in FIG. 1. The housing 10 is characterized that it has an opening 11 for letting a hand H of a user access the operating space S in the housing 10. In order not to directly contact/rub the components installed in the operating space S in the housing 10, a separation cloth cover 12 can be fixed on the opening 11 and extended into the operating space S. The separation cloth cover 12 is soft and smooth on the surface. It can be used to separate the hand H from the components, especially the massage module 20, thus the hand H will not contact or rub with the components.

The massage module 20 is the element of the smart hand massager 1 to perform massage for the hand H. The massage module 20 is installed in the operating space S of the housing 10. It is controlled by the control module 60 to massage a portion of the hand H in different modes. According to the present invention, the type of the massage module 20 is not restricted. In practice, the massage module 20 is better to be pressure type, roller type or vibration type and used in the smart hand massager 1. In FIG. 3, the massage module 20 in the first embodiment is pressure type. It has an upper massage cushion 21 and a bottom massage cushion 22. Both the upper massage cushion 21 and the bottom massage cushion 22 have a number of massage points P on the surface and 3 air bags A inside (shown by dashed frame). The air bags A are inflated and deflated alternately, forcing some massage points P to press a local area of the hand H. As to the modes of the smart hand massager 1, different modes may operate in different strengths to the hand H, different durations, different speeds or different periods, according to the type of the massage module 20 and design of the smart hand massager 1.

In the embodiments, the number of speakers 30 is 2. It means that there are two speakers 30, installed on the two opposite sides of the housing 10. The speakers 30 are controlled by the control module 60 to play music or sound. The speakers 30 is used to add some fun for the users when they are using the smart hand massager 1 to release the soreness of their hands. It is boring to watch the smart hand massager 1 operating monotonously for a period of time. The music or sound may be played independently, or changeably with the mode the massage module 20. For example, when the mode is slow speed, soft music is played, and when the mode is fast speed, rock music is played.

The hand sensor 40 is one of the technical features of the present invention. The hand sensor 40 is installed in the operating space S. It can sense the hand H accessing the operating space S and sends an activating signal when the hand H is sensed. The smart hand massager 1 will not massage the hand H, even if it is powered on until the hand H is detected by the hand sensor 40. The activating signal can be seen as a command for the control module 60 to order the massage module 20 to run. According to the present invention, the hand sensor 40 may be, but not limited to an inductive sensor, a capacitive sensor, a photoelectric sensor, an ultrasonic sensor, an infrared sensor, a radar sensor or a sonar sensor. Most important of all, when the hand sensor 40 is installed, there should be no other elements, e.g., the separation cloth cover 12, between it and the hand H. The specific position of the hand sensor 40 in the operating space S is not restricted.

The control panel 50 is installed on the housing 10, facing the external environment for users to operate. It is operated to send commands to the control module 60. The control panel 10 may be a mechanical structure and have a number of physical buttons. One specified command, e.g., a mode change command to change the current mode of the massage module 20, will be sent to the control module 60 by the control panel 60 when a corresponding physical button, e.g., a mode button, is pressed. The control panel 50 can also be like the one in FIG. 1, which is a touch panel. The control panel 50 forms a number of virtual buttons B. Similarly, under this design, one specified command will be sent by the control panel 50 when a corresponding virtual button B is pressed. Besides the mode button, there might be other virtual button B to send corresponding command to the control module 60. For example, a music/sound select button for sending a music/sound command to the control module 60 to make the speakers 30 when pressed to play an assigned music or sound; a temperature button for sending a temperature command to the control module 60 to change the temperature in the operating space S by the heater 70; a power button for sending a power command to the control module 60 to is turn on or off the power module 80, etc.

The control module 60 is a collection of electronic components, including at least a controller, active components and passive components assembled on at least one print circuit board. The control module 60 is installed in the operating space S and signally connected to the heater 70, the control panel 50, the hand sensor 40, the speakers 30 and the massage module 20. As mentioned above, the control module 60 can control the massage module 20 to operate in a specified mode, the at speakers 30 to play a specified music or sound, the heater 70 to heat the operating space S according to the commands from the control panel 50 when the activating signal from the hand sensor 40 is received. The control module 60 may include a memory unit 61. The memory unit 61 can store files of music, sounds, movies and images. The files of movies and images are used in a second embodiment of the present invention.

The heater 70 may be any device which generates heat with electric power. The heater 70 is installed in the operating space S, electrically connected to the power module 80 and signally connected to the control module 60. The heater 70 generates heat in the operating space S at different temperatures according to a command from the control panel 50 through the control module 60.

The power module 80 is installed on the housing 10 and may be totally enclosed by the housing 10 or partially exposed to the external environment. The power module 80 receives power (electric power) from a power source, transfers the power to different volts and provides the transferred power to the heater 70, the control module 60, the control panel 50, the hand sensor 40, the speakers 30 and the massage module 20 which are electrically connected to the power module 80. The power module 80 has various structure. In this embodiment, the power module 80 includes a power distribution circuit 81 and a battery box 82 electrically connected to the power distribution circuit 81. Thus, the power source is a battery 821 or batteries electrically installed in the battery box 82. The battery 821 may be a rechargeable battery. A charger (not shown) may be further connected to the battery box 82 for charging the battery 821 when its power is low. Another structure of the power module 80 will be illustrated in the second embodiment.

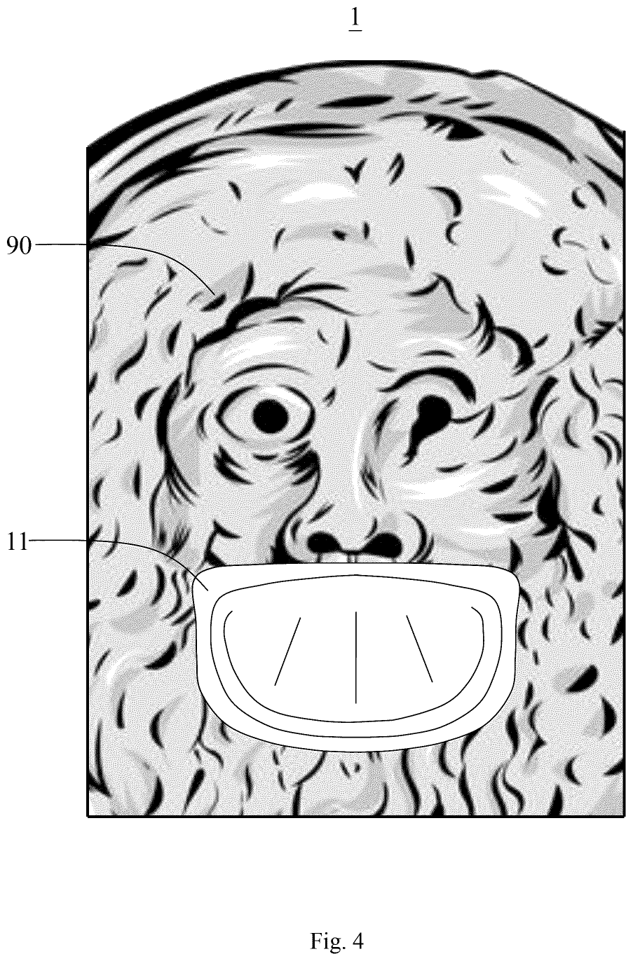

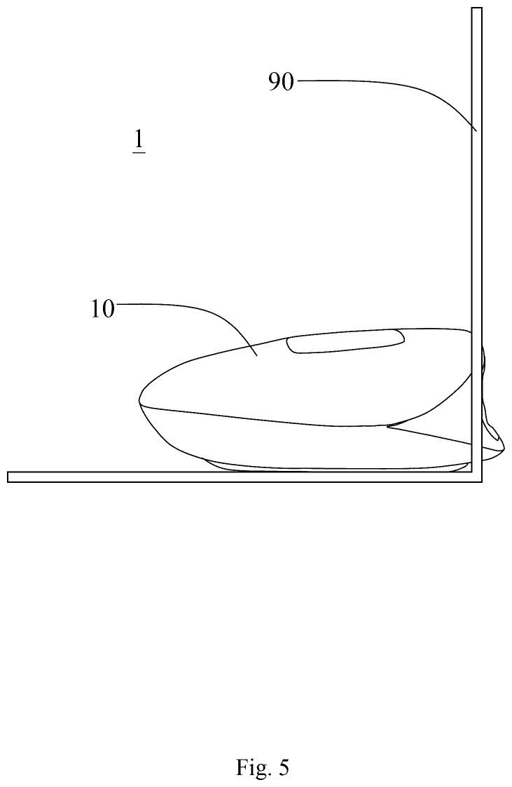

See FIG. 4 and FIG. 5. FIG. 4 is a front view of the smart hand massager 1 when an image board 90 is mounted on. FIG. 5 is a side view of the smart hand massager 1 when the image board 90 is mounted on. The smart hand massager 1 may further include the image board 90, removably or rotatably mounted on the housing 10 (at the opening 11), for showing an image picture on it. The image board 90 is a decoration and also adds some fun for the users when they are using the smart hand massager 1. In this embodiment, the image board 90 is a cardboard and rotatably mounted on the housing 10. A front side is painted with an image of the “mouth of truth” with the mouth portion engaged with the opening 11. When users use the smart hand massager 1, they may feel as if their hands go deep into the mouth of truth. Preferably, the speakers 30 could play the music of “yesterday once more”. Thus, for elder users, this will bring back memories of the movie “Roman Holiday”. The image board 90 may also be made of plastic. It is rigid and not able to bend or fold. Hence, under this condition, the image board 90 is removably mounted on the housing 10.

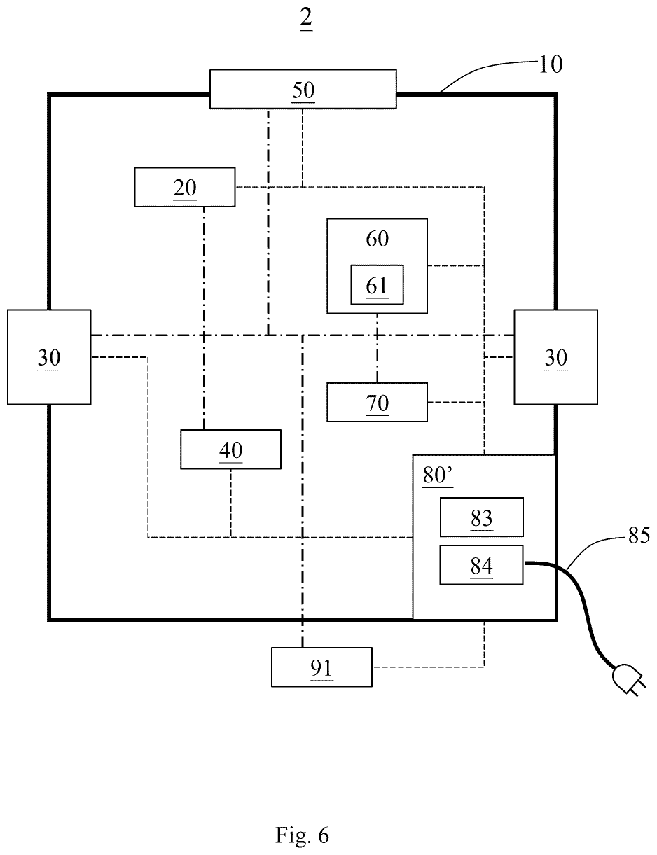

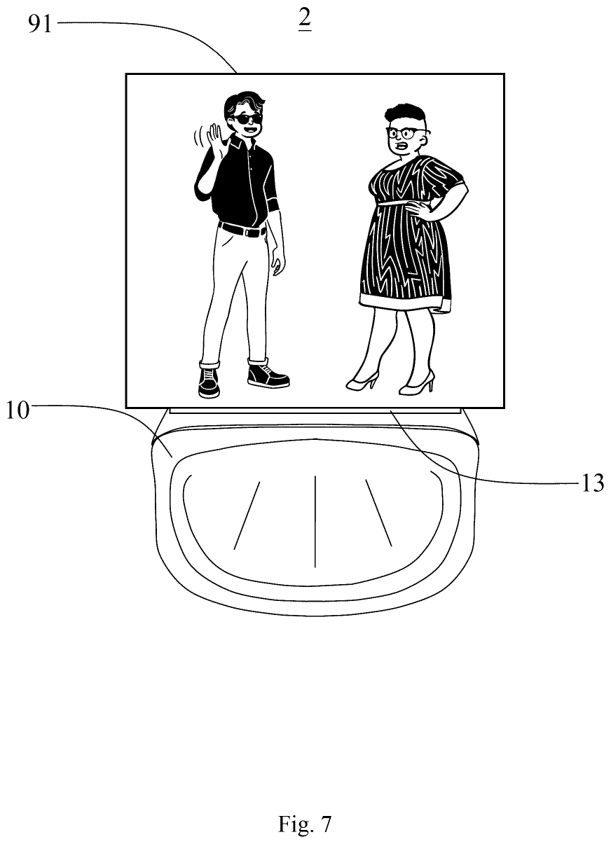

See FIG. 6 and FIG. 7. FIG. 6 is a block diagram of a smart hand massager 2 according to the second embodiment of the present invention. FIG. 7 is a side view of the smart hand massager 2 when a monitor 91 is fixed on. To simplify the description, the same symbols as in the previous figures are used in FIG. 6 and FIG. 7 to represent the same elements. In FIG. 6, one difference between the first embodiment and the present embodiment is the power module 80′. The power module 80′ of the smart hand massager 2 comprises a power distribution circuit 83, a transformer 84 electrically connected to the power distribution circuit 83, and a wire 85 electrically connected to the transformer 84. The power source is an electrical socket (not shown) that a plug of the wire 85 plugged into. It means the power module 80′ is able to receive AC power and transfer it into DC power for use.

In FIG. 7, the other difference between the first embodiment and the present embodiment is the image board 90 is replaced with a monitor 91. The monitor 91 is removably fixed on the housing 10. In this embodiment, it may be fixed in a fixing groove 13 of the housing 10. The monitor 91 is electrically connected to the power module 80′ and signally connected to the control module 60 to display a movie or an image according to a command from the control panel 50 through the control module 60. Files of movies and images can be stored in the memory unit 61 for users to choose. The music of the movie can be played by the speakers 30. The monitor 91 can provide entertainment videos to users to kill boring waiting time. Preferably, the monitor can be a Liquid Crystal Display (LCD), a Thin Film Transistor Liquid Crystal Display (TFT-LCD), an Organic Light Emitting Diode (OLED) display, a plasma display, a Light Emitting Diode (LED) display, or even an e-paper.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A smart hand massager, comprising:
a housing, having an opening for letting a hand access an operating space therein;
a massage module, installed in the operating space, being controlled to massage a portion of the hand in different modes;
at least one speaker, installed on the housing, being controlled to play music or sound;
a hand sensor, installed in the operating space, sensing the hand accessing the operating space and sending an activating signal when the hand is sensed;
a control panel, installed on the housing, being operated to send commands;
a control module, installed in the operating space and signally connected to the control panel, the hand sensor, the at least one speaker and the massage module, controlling the massage module to operate in a specified mode and the at least one speaker to play a specified music or sound according to the commands from the control panel when the activating signal is received; and
a power module, installed on the housing, receiving power from a power source, transferring the power and providing transferred power to the control module, the control panel, the hand sensor, the at least one speaker and the massage module electrically connected thereto.

2. The smart hand massager according to claim 1, further comprising an image board, removably or rotatably mounted on the housing, for showing an image picture thereon.

3. The smart hand massager according to claim 1, further comprising a monitor, removably fixed on the housing, electrically connected to the power module and signally connected to the control module, displaying a movie or an image according to a command from the control panel through the control module.

4. The smart hand massager according to claim 3, wherein the monitor is a Liquid Crystal Display (LCD), a Thin Film Transistor Liquid Crystal Display (TFT-LCD), an Organic Light Emitting Diode (OLED) display, a plasma display, a Light Emitting Diode (LED) display, or an e-paper.

5. The smart hand massager according to claim 3, wherein the control module further comprises a memory unit, storing files of music, sounds, movies and images.

6. The smart hand massager according to claim 1, further comprising a heater, installed in the operating space, electrically connected to the power module and signally connected to the control module, generating heat in the operating space at different temperatures according to a command from the control panel through the control module.

7. The smart hand massager according to claim 1, wherein the massage module is pressure type, roller type or vibration type.

8. The smart hand massager according to claim 1, wherein different modes operate in different strengths to the hand, different durations, different speeds or different periods.

9. The smart hand massager according to claim 1, wherein the hand sensor is an inductive sensor, a capacitive sensor, a photoelectric sensor, an ultrasonic sensor, an infrared sensor, a radar sensor or a sonar sensor.

10. The smart hand massager according to claim 1, wherein the control panel is a touch panel and forms a plurality of virtual buttons, and one specified command is sent by the control panel when a corresponding virtual button is pressed.

11. The smart hand massager according to claim 1, wherein the control panel has a plurality of physical buttons, and one specified command is sent by the control panel when a corresponding physical button is pressed.

12. The smart hand massager according to claim 1, wherein the power module comprises a power distribution circuit and a battery box electrically connected thereto.

13. The smart hand massager according to claim 12, wherein the power source is a battery or batteries electrically installed in the battery box.

14. The smart hand massager according to claim 1, wherein the power module comprises a power distribution circuit, a transformer electrically connected to the power distribution circuit, and a wire electrically connected to the transformer.

15. The smart hand massager according to claim 14, wherein the power source is an electrical socket that a plug of the wire plugged into.

16. The smart hand massager according to claim 1, wherein a separation cloth cover is further fixed on the opening and extended into the operating space to separate the hand from the massage module.
